(19) United States
(12) Patent Application Publication
(10) Pub. No.: US 2011/0199387 A1
(43) Pub. Date: Aug. 18, 2011

(54) Activating Features on an Imaging Device Based on Manipulations

(76) Inventor: John David Newton, Auckland (NZ)

(21) Appl. No.: 12/952,580

(22) Filed: Nov. 23, 2010

(30) Foreign Application Priority Data
Nov. 24, 2009 (AU) 2009905748

(51) Int. Cl. G09G 5/00

(52) U.S. Cl. 345/619

(57) ABSTRACT

Certain aspects and embodiments of the present invention relate to manipulating elements to control an imaging device. According to some embodiments, the imaging device includes a memory, a processor, and a photographic assembly. The photographic assembly includes sensors that can detect and image an object in a viewing area of the imaging device. One or more computer programs can be stored in the memory to determine whether identifiable elements used in the manipulation exist. Manipulations of these elements are compared to stored manipulations to locate a match. In response to locating a match, one or more functions that correspond to the manipulation can be activated on the imaging device. Examples of such functions include the zoom and focus features typically found in cameras, as well as features that are represented as “clickable” icons or other images that are superimposed on the screen of the imaging device.

### CROSS-REFERENCE TO RELATED APPLICATIONS

This application claims priority to Australian Provisional Application No. 2009905748 naming John Newton as inventor, filed on Nov. 24, 2009, and entitled “A Portable Imaging Device,” which is incorporated by reference herein in its entirety.

### TECHNICAL FIELD

The present invention relates generally to portable imaging devices and more specifically to controlling features of the imaging devices with gestures.

### BACKGROUND

Portable imaging devices are increasingly being used to capture still and moving images. Capturing images with these devices, however, can be cumbersome because buttons or components used to capture the images are not always visible to a user who is viewing the images through a viewfinder or display screen of the imaging device. Such an arrangement can cause delay or disruption of image capture because a user oftentimes loses sight of the image while locating the buttons or components. Thus, a mechanism that allows a user to capture images while minimizing distraction is desirable.

Further, when a user is viewing images through the viewfinder of the portable imaging device it is advantageous for the user to dynamically control the image to be captured by the portable imaging device, by manipulating controls of the device which are superimposed atop the scene viewed through the viewfinder.

### SUMMARY

Certain aspects and embodiments of the present invention relate to manipulating elements to control an imaging device. According to some embodiments, the imaging device includes a memory, a processor, and a photographic assembly. The photographic assembly includes sensors that can detect and image an object in a viewing area of the imaging device. One or more computer programs can be stored in the memory to configure the processor to perform steps to control the imaging device. In one embodiment, those steps include determining whether the image shown in the viewing area comprises one or more elements which can be manipulated to control the imaging device. The manipulation of the one or more elements can be compared to manipulations stored in the memory to identify a manipulation that matches the manipulation of the one or more elements. In response to a match, a function on the imaging device that corresponds to the manipulation can be performed.

These illustrative aspects are mentioned not to limit or define the invention, but to provide examples to aid understanding of the inventive concepts disclosed in this application. Other aspects, advantages, and features of the present invention will become apparent after review of the entire application.

### BRIEF DESCRIPTION OF THE DRAWINGS

FIG. 1A is an illustration of the components of an imaging device, according to an exemplary embodiment.

FIG. 1B is an illustration of a manipulation being performed in a viewing area of the imaging device and detected by sensors, according to an exemplary embodiment.

FIG. 2 is an illustration of the interaction between an image superimposed over another image based on a manipulation that contacts one of the images, according to one embodiment.

FIG. 3 is a flow diagram of an exemplary embodiment for controlling an imaging device by manipulating elements, according to one embodiment.

FIG. 4 shows an illustrative manipulation detected by an imaging device using an auxiliary sensor.

FIG. 5 shows an illustrative manipulation detected by an imaging device without use of an onscreen menu.

FIGS. 6A-6B show examples of manipulations detected by an imaging device.

### DETAILED DESCRIPTION

An imaging device can be controlled by manipulating elements or objects within a viewing area of the imaging device. The manipulations can have the same effect as pressing a button or other component on the imaging device to activate a feature of the imaging device, such as zoom, focus, or image selection. The manipulations may also emulate a touch at certain locations on the viewing area screen to select icons or keys on a keypad. Images can be captured and superimposed over identical or other images to facilitate such manipulation. Manipulations of the elements can be captured by a photographic assembly of the imaging device (and/or another imaging component) and can be compared to manipulations stored in memory (i.e., stored manipulations) to determine whether a match exists. Each stored manipulation can be associated with a function or feature on the imaging device such that performing the manipulation will activate the associated feature. One or more attributes can also be associated with the feature to control the behavior of the feature. For instance, the speed in which the manipulations are made can determine the magnitude of the zoom feature.

Reference will now be made in detail to various and alternative exemplary embodiments and to the accompanying drawings. Each example is provided by way of explanation, and not as a limitation. It will be apparent to those skilled in the art that modifications and variations can be made. For instance, features illustrated or described as part of one embodiment may be used on another embodiment to yield a still further embodiment. Thus, it is intended that this disclosure includes modifications and variations as come within the scope of the appended claims and their equivalents.

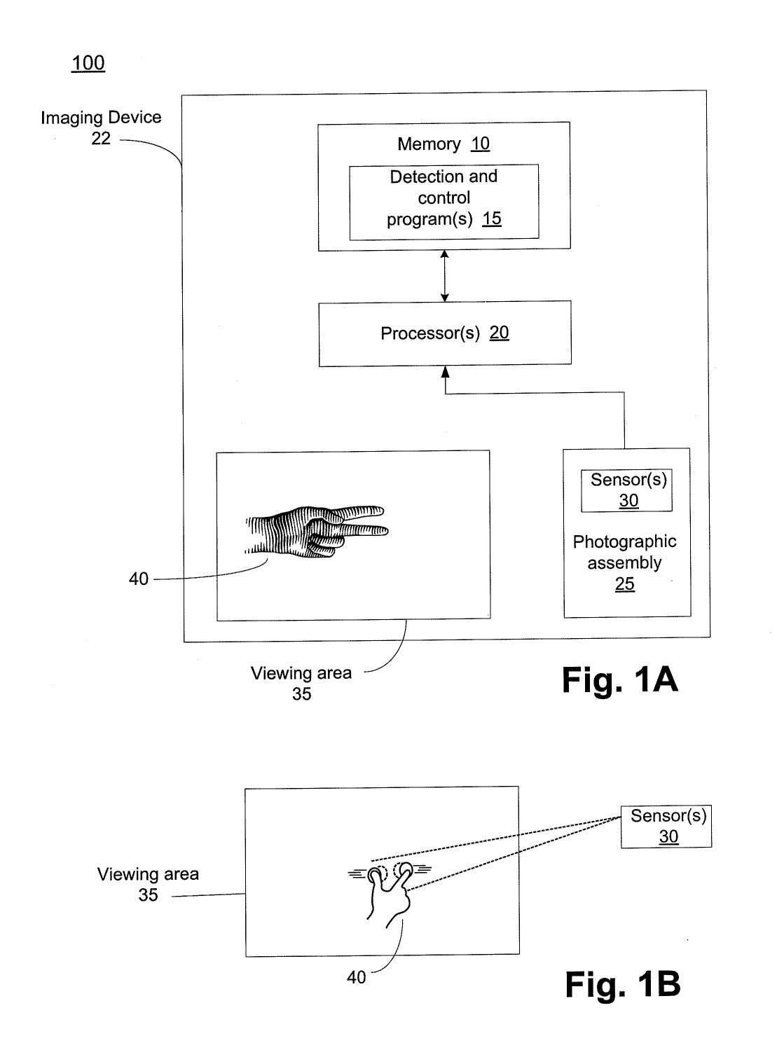

FIG. 1A depicts the components of an imaging device 22, according to an exemplary embodiment. A photographic assembly 25 can be used to capture images, such as the elements 40, in a viewing area 35. In this example, imaging device 22 provides a display or view of viewing area 35 via an LCD and/or other display screen. It will be understood that, in addition to or instead of a display screen, viewing area 35 may represent a viewfinder. In other embodiments, an eyepiece can be used to provide a similar view.

A memory 10 can store data and embody one or more computer program components 15 that configure a processor 20 to identify and compare manipulations and activate associated functions. The photographic assembly 25 can include sensors 30, which perform the conventional function of rendering images for capture. In some embodiments, however, any technology that can detect an image and render it for capture by the photographic assembly 25 can be used. The basic operation of image capture is generally well known in the art and is therefore not further described herein.

Elements 40 can be used to make manipulations while displayed in the viewing area 35. As shown in FIGS. 1A and 1B, the elements 40 can be a person's fingers. Additional examples of the elements 40 can include a pen, stylus, or like object. In one embodiment, a limited number of the elements 40 can be stored in the memory 10 as acceptable objects for performing manipulations. According to this embodiment, fingers, pens, and styluses may be acceptable objects but objects that are generally circular, for example, may not be acceptable. In another embodiment, any object that can be manipulated can be used.

Numerous manipulations of the elements 40 can be associated with functions on the imaging device. Examples of such manipulations include, but are not limited to, a pinching motion, a forward-backward motion, a swipe motion, a rotating motion, and a pointing motion. Generally, the manipulations can be recognized by tracking one or more features (e.g., fingertips) over time, though more advanced image processing techniques (e.g., shape recognition) could be used as well.

The pinching manipulation is illustrated in FIG. 1B. The sensors 30 can detect that two fingers that were originally spaced apart are moving closing to each other (pinching gesture) and capture data associated with the pinching gesture for processing by the processor 20 (as described in further detail below). Upon recognizing the pinching motion, the zoom feature on the imaging device 22 can be activated. As another example, the zoom feature can also be activated by bringing one finger toward the imaging device 22 and then moving the finger away from the imaging device 22 (forward-backward manipulation).

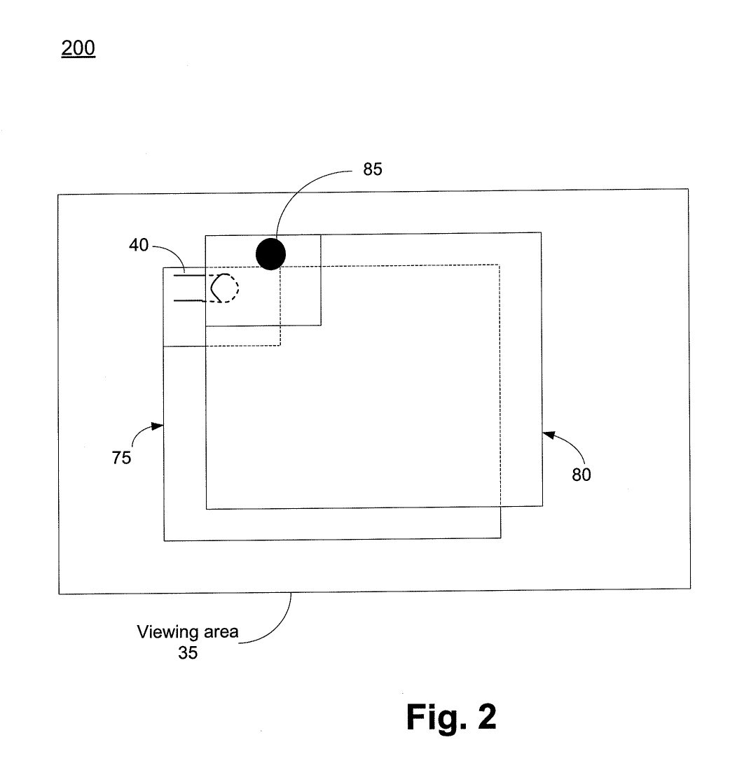

Other manipulations may be used for other commands. For instance, a swipe motion, or moving an element rapidly across the field of view of the viewing area 35, can transition from one captured image to another image. Rotating two elements in a circular motion can activate a feature to focus a blurred image, set a desired zoom amount, and/or adjust another camera parameter (e.g., f-stop, exposure, white balance, ISO, etc). Positioning or pointing an element 40 at a location on the viewfinder or LCD screen that corresponds to an object that is superimposed on the screen can emulate selection of the object. Similarly, “virtually” tapping an object in the viewing area 35 that has been overlaid with an image on the viewfinder can also emulate selection of the object. In one embodiment, the object can be an icon that is associated with an option or feature of the imaging device. In another embodiment, the object can be a key on a keypad, as illustrated in FIG. 2 and discussed in further detail below.

The manipulations described above are only examples. Various other manipulations can be used to activate the same features described above, just as those manipulations can be associated with other features. Additionally, the imaging device 22 can be sensitive to the type of elements 40 that is being manipulated. For example, in one embodiment, two pens that are manipulated in a pinching motion may not activate the zoom feature. In other embodiments that are less sensitive to the type of element 40, pens manipulated in such fashion can activate the zoom feature. For that matter, any object that is manipulated in a pinching motion, for example, can activate the zoom feature. Data from the sensors 30 can be used to detect attributes such as size and shape to determine which of the elements 40 is being manipulated. Numerous other attributes regarding the manipulations and the elements used to perform the manipulations may be captured by the sensors 30, such as the speed and number of elements 40 used to perform the manipulations. In one embodiment, the speed can determine the magnitude of the zoom feature, e.g., how far to zoom in on or away from an image. The manipulations and associated data attributes can be stored in the memory 10.

The one or more detection and control programs 15 contain instructions for controlling the imaging device 22 based on the manipulations of one or more elements 40 detected in the viewing area 35. According to one embodiment, the processor 20 compares manipulations of the elements 40 to stored manipulations in the memory 10 to determine whether a match between the manipulation of the elements 40 matches at least one of the stored manipulations in the memory 10. In one embodiment, a match can be determined by a program of the detection and control programs 15 that specializes in comparing still and moving images. A number of known techniques may be employed within such a program to determine a match.

Alternatively, a match can be determined by recognition of the manipulation as detected by the sensors 30. As the elements 40 are manipulated, the processor 20 can access the three-dimensional positional data captured by the sensors 30. In one embodiment, the manipulation can be represented by the location of the elements 40 at particular time. After the manipulation is completed (as can be detected by removal of the elements 40 from the view of the viewing area 35 after a deliberate pause, in one embodiment), the processor can analyze the data associated with the manipulation. This data can be compared to data stored in the memory 10 associated with each stored manipulation to determine whether a match exists. In one embodiment, the detection and control programs 15 contain certain tolerance levels that forgive inexact movements by the user. In a further embodiment, the detection and control programs 15 can prompt the user to confirm the type of manipulation to be performed. Such a prompt can be overlaid on the viewfinder or LCD screen of the imaging device 22. The user may confirm the prompt by, for example, manipulating the elements 40 in the form of a checkmark. An “X” motion of the elements 40 can denote that the intended manipulation was not found, at which point the detection and control programs 15 can present another stored manipulation that resembles the manipulation of the elements 40. In addition to capturing positional data, other techniques may be used by the sensors 30 and interpreted by the processor 20 to determine a match.

FIG. 2 illustrates the effect of a manipulation that may be made to select buttons or other components that exist on an imaging device 22. As shown in FIG. 2, an image 80 can be superimposed over another image 75 shown in the viewing area 35 while image 75 is captured by the device. Image 80 may be captured by the imaging device, may be retrieved from memory, or may be a graphic generated by the imaging device. The dotted lines represent the portion of image 75 that is underneath the image 80. In FIG. 2, image 80 is slightly offset from image 75 to provide a three-dimensional-like view of the overlay. Image 80 may exactly overlay image 75 in an actual embodiment.

In the embodiment shown in FIG. 2, the images 80 and 75 are identical keypads (with only the first key shown for simplicity) that are used to dial a number on a phone device. Such an arrangement facilitates the accurate capture of manipulations because objects on the actual keypad are aligned with those in the captured image. In another embodiment, the image 80 can be a keypad that is superimposed over a flat surface such as a desk. In either embodiment, a finger 40 can “virtually” touch or tap a location on image 75 that corresponds to the same location on the image 80 (i.e., location 85). The sensors 30 can detect the location of the touch and use this same location to select the object superimposed on a viewfinder of the imaging device 22. For example, if the touch occurred at XYZ pixel coordinate 30, 50, 10, the sensors 30 can send this position to the processor 20, which can be configured to select the object on the viewfinder that corresponds to the XY pixel coordinate 30, 50. In one embodiment, if no object is found at this exact location on the screen, the processor 20 can select the object that is nearest this pixel location. Thus, in the embodiment shown in FIG. 2, a touch of the finger 40 as imaged in image 75 can cause the selection of the number ‘1’ on a keypad that is superimposed on the viewfinder, which can in turn dial the digit ‘1’ on a communications device.

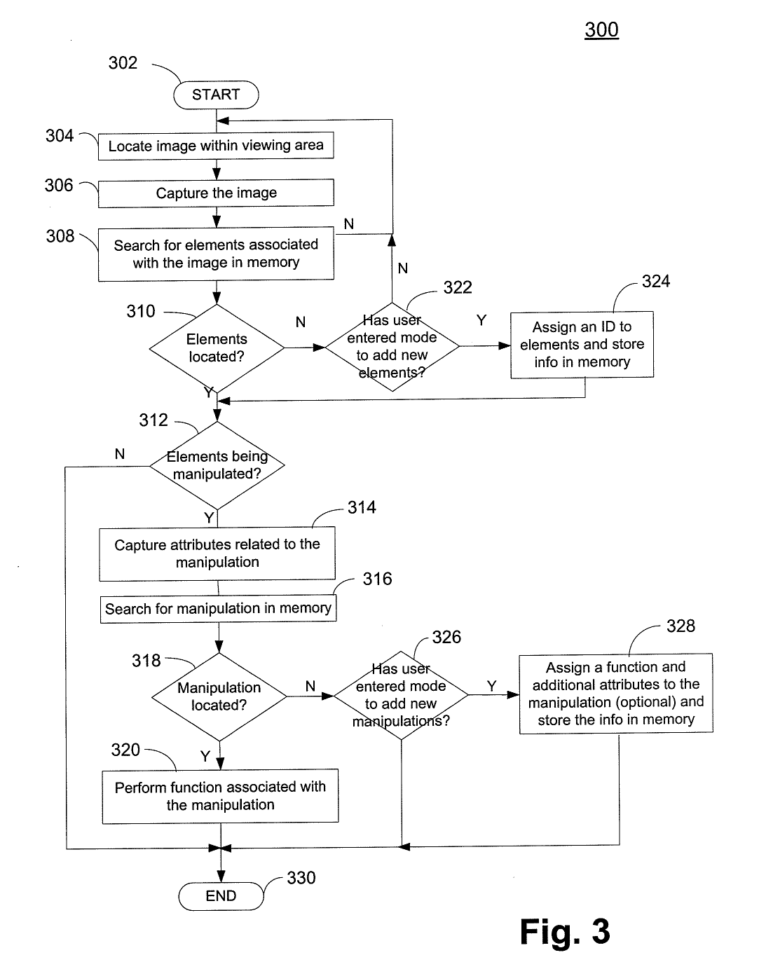

FIG. 3 is a process flow diagram of an exemplary embodiment of the present invention. Although FIG. 3 describes the manipulation of elements associated with one image, multiple images can be processed according to various embodiments. In the embodiment shown in FIG. 3, an image can be located within the borders of a viewing area of an imaging device at step 304 and captured at step 306. The captured image can be searched in the memory 10 to determine whether the image is one of the acceptable predefined elements for performing manipulations (step 308). If the elements are not located at decision step 310, a determination can be made at step 322 as to whether a request has been sent to the imaging device to add a new object to the list of predefined elements. If such a request has been made, the captured image representing the new object can be stored in memory as an acceptable element for performing manipulations.

If the elements are located at step 310, a determination can be made as to whether the elements are being manipulated at step 312. One or more attributes that relate to the manipulation (e.g., speed of the elements performing the manipulation) can be determined at step 314. The captured manipulation can be compared to the stored manipulations at step 316 to determine whether a match exists. If a match is not found at decision step 318, a determination similar to that in step 322 can be made to determination whether a request has been sent to the imaging device to add new manipulations to the memory 10 (step 326). In the embodiment in which the sensors 30 determine the manipulation that was made, an identifier and function associated with the manipulation can be stored in memory rather than an image or data representation of the manipulation.

If the manipulation is located at step 318, the function associated with the manipulation can be performed on the imaging device according to the stored attributes at step 320. For example, the zoom function can be performed at a distance that corresponds to the speed of the elements performing the manipulation. The memory 10 can store a table or other relationship that links predefined speeds to distances for the zoom operation. A similar relationship can exist for every manipulation and associated attributes. In one embodiment, multiple functions can be associated with a stored manipulation such that successive functions are performed. For example, the pinching manipulation may activate the zoom operation followed by enablement of the flash feature.

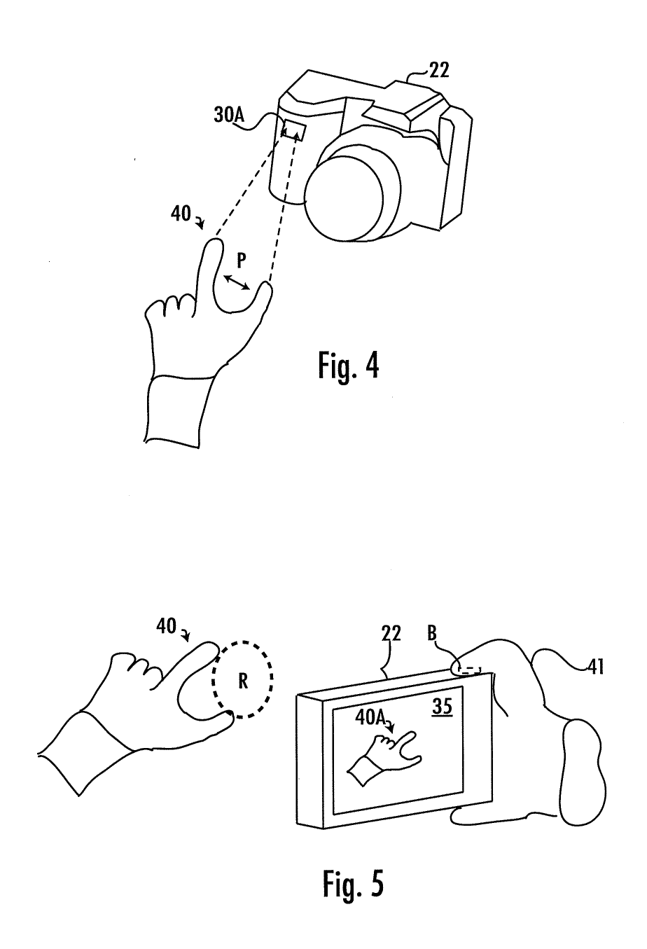

FIG. 4 shows an illustrative manipulation detected by an imaging device 22 using an auxiliary sensor 30A. As was noted above, embodiments of an imaging device can use the same imaging hardware (e.g., camera sensor) used to capture images. However, in addition to or instead of using the imaging hardware, one or more other sensors can be used. As shown at 30A, one or more sensors are used to detect pinching gesture P made by manipulating elements 40 in the field of view of imaging device 22. This manipulation can be correlated to a command, such as a zoom or other command. Sensor(s) 30A may comprise hardware used for other purposes by imaging device 22 (e.g., for autofocus purposes) or may comprise dedicated hardware for gesture recognition. For example, sensor(s) 30A may comprise one or more area cameras. In this and other implementations, the manipulations may be recognized using ambient light and/or through the use of illumination provided specifically for recognizing gestures and other manipulations of elements 40. For example, one or more sources, such as infrared light sources, may be used when the manipulations are to be detected.

FIG. 5 shows an illustrative manipulation detected by an imaging device without use of an onscreen menu. Several examples herein discuss implementations in which manipulations of elements 40 are used to select commands based on proximity and/or virtual contact with one or more elements in a superimposed image. However, the present subject matter is not limited to the use of superimposed images. Rather, menus and other commands can be provided simply by recognizing manipulations while a regular view is provided. For instance, as shown in FIG. 5, elements 40 are being manipulated to provide a rotation gesture R as indicated by the dashed circle. Viewscreen 35 provides a representation 40A of the field of view of imaging device 22. Even without superimposing an image, rotation gesture R may be used for menu selections or other adjustments, such as selecting different imaging modes, focus/zoom commands, and the like.

FIG. 5 also shows a button B actuated by a thumb on the hand 41 that is used (in this example) to support imaging device 22. In some implementations, one or more buttons, keys, or other hardware elements can be actuated. For example, manipulations of elements 40 can be used to move a cursor, change various menu options, and the like, while button B is used as a click or select indicator. Additionally or alternatively, button B can be used to activate or deactivate recognition of manipulations by device 22.

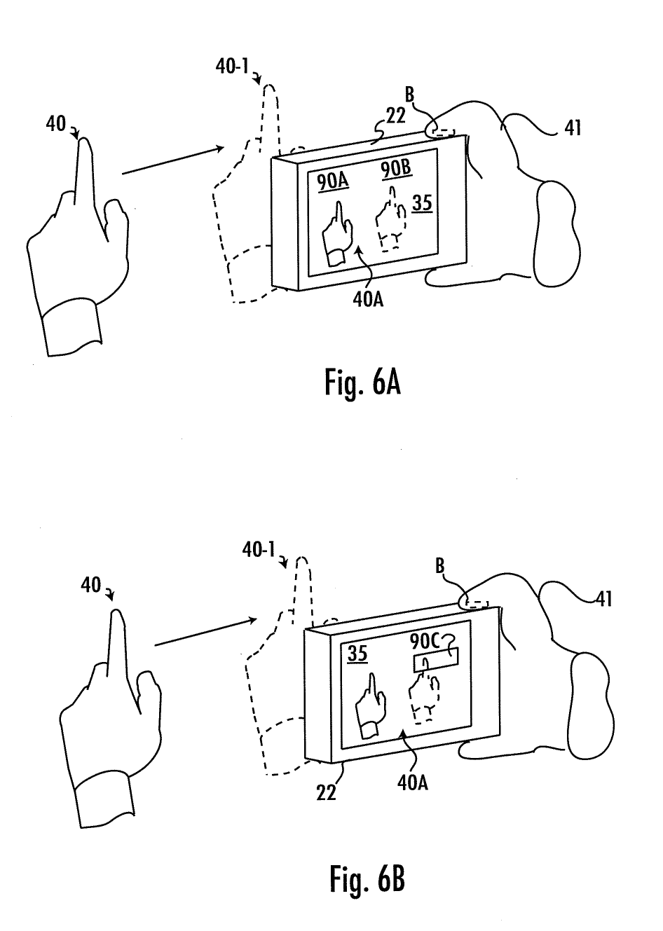

FIGS. 6A-6B show examples of manipulations detected by an imaging device. In both examples, elements 40 comprise a user's hand that is moved to the position shown in dashed lines at 40-1. As shown at 40A, screen 35 provides a representation of elements 40.

In the example of FIG. 6A, elements 40 move from pointing at a first region 90A of screen 35 to a second region 90B. For example, regions 90A and 90B may represent different menu options or commands. The different menu options may be selected at the appropriate time by actuating button B. Of course, button B need not be used in all embodiments; as another example, regions 90A and/or 90B may be selected by simply lingering or pointing at the desired region.

FIG. 6B shows an example using a superimposed image. In this example, in screen 35, an image containing element 90C is superimposed onto the image provided by the imaging hardware of device 22. Alternatively, of course, the image provided by the imaging hardware of device 22 could be superimposed onto the image containing element 90C. In any event, in this example, elements 40 are manipulated such that the representation 40A of elements 40 intersects or enters the same portion of the screen occupied by element 90C. This intersection/entry alone can be treated as selection of element 90C or invoking a command associated with element 90C. However, in some embodiments, selection does not occur unless button B is actuated while the intersection/entry occurs.

Embodiments described herein include computer components, such as processing devices and memory, to implement the described functionality. Persons skilled in the art will recognize that various parameters of each of these components can be used in the present invention. For example, some image comparisons may be processor-intensive and therefore may require more processing capacity than may be found in a portable imaging device. Thus, according to one embodiment, the manipulations can be sent real-time via a network connection for comparison by a processor that is separate from the imaging device 22. The results from such a comparison can be returned to the imaging device 22 via the network connection. Upon detecting a match, the processor 20 can access the memory 10 to determine the identification of the function that corresponds to the manipulation and one or more attributes (as described above) used to implement this function. The processor 20 can be a processing device such as a microprocessor, DSP, or other device capable of executing computer instructions.

Furthermore, in some embodiments, the memory 10 can comprise a RAM, ROM, cache, or another type of memory. As another example, memory 10 can comprise a hard disk, removable disk, or any other storage medium capable of being accessed by a processing device. In any event, memory 10 can be used to store the program code that configures the processor 20 or similar processing device to compare the manipulations and activate a corresponding function on the imaging device 22. Such storage mediums can be located within the imaging device 22 to interface with a processing device therein (as shown in the embodiment in FIG. 1), or they can be located in a system external to the processing device that is accessible via a network connection, for example.

Of course, other hardware configurations are possible. For instance, rather than using a memory and processor, an embodiment could use a programmable logic device such as a FPGA.

Examples of imaging devices depicted herein are not intended to be limiting. Imaging device 22 can comprise any form factor including, but not limited to still cameras, video cameras, and mobile devices with image capture capabilities (e.g., cellular phones, PDAs, “smartphones,” tablets, etc.).

It should be understood that the foregoing relates only to certain embodiments of the invention, which are presented by way of example rather than limitation. While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure does not preclude inclusion of such modifications, variations and/or additions to the present subject matter as would be readily apparent to one of ordinary skill in the art upon review of this disclosure.

1. A device comprising:
a memory;
a processor;
a photographic assembly comprising one or more sensors for detecting an image displayed in a viewing area; and
computer-executable instructions in the memory that configure the device to:
determine whether the image comprises one or more elements;
determine, from the image, a manipulation of the one or more elements;
compare a manipulation of the one or more elements to stored manipulations in memory to identify a manipulation that matches the manipulation of the one or more elements; and
in response to a match, perform a function on the imaging device that corresponds to the manipulation of the stored manipulations.

2. The device of claim 1 wherein determining the manipulation comprises identifying a virtual touch of an object displayed in the viewing area by the one or more elements.

3. The device of claim 2 wherein the object is a key on a keypad comprising a plurality of keys.

4. The device of claim 1 wherein the instructions further configure the device to store the stored manipulations in the memory, wherein storing comprises:
capturing the manipulation and one or more attributes associated with the manipulation;
assigning one or more functions to the manipulation; and
storing the manipulation, the function, and the one or more attributes in the memory.

5. The device of claim 1 wherein the manipulation of the one or more elements causes the processor to execute instructions to activate a zoom operation of the imaging device, wherein the manipulation comprises:
moving the one or more elements in a pinching motion; or
moving an element of the one or more elements toward a screen of the imaging device then away from the screen of the imaging device; or
moving the one or more elements in a rotation motion;
wherein a distance of the zoom operation is determined by one or more attributes of the manipulation, the one or more attributes comprising a speed of the moving the element.

6. The device of claim 1 wherein the manipulation of the one or more elements comprises rotating at least two elements in a circular motion, wherein the rotating activates the focus operation of the imaging device.

7. The device of claim 1 wherein the movement of the one or more elements comprises a swipe motion, wherein the swipe motion causes the processor to execute instructions to display a second image in place of a first image on a screen of the imaging device.

8. The device of claim 1 wherein the movement of the one or more elements comprise positioning an element of the one or more elements in a location that corresponds to an object on a screen of the imaging device, wherein the positioning causes the selection of the object displayed on the screen.

9. The device of claim 8 wherein the object is an icon.

10. The device of claim 1 wherein the match comprises prompting a user to confirm that the manipulation of the stored manipulations is a function intended to be performed by the manipulation of the one or more elements.

11. The device of claim 1 wherein the function that is performed is based on the type of the one or more elements.

12. The device of claim 1 wherein the manipulation of the one or more elements is located at a distance away from a surface of a screen of the imaging device.

13. The device of claim 1 wherein the device is a digital camera.

14. The device of claim 1 wherein the device comprises a mobile device.

15. The device of claim 1, wherein the instructions further configure the processor to determine the command based on actuation of one or more hardware keys or buttons of the device.

16. A computer-implemented method, comprising:
obtaining image data representing a viewing area of a device;
based on the image data, recognizing at least one element in the viewing area;
identifying, from the image data, a manipulation of the at least one element;
searching a set of stored manipulations for a matching manipulation that is the same as or substantially the same as the identified manipulation; and
carrying out a command that corresponds to the matching manipulation, if a matching manipulation is found.

17. The method of claim 16, further comprising storing a manipulation of the set of stored manipulations in the memory, wherein the storing comprises:
capturing the identified manipulation and one or more attributes associated with the identified manipulation;
assigning one or more functions to the identified manipulation; and
storing the identified manipulation, the one or more functions, and the one or more attributes in the memory.

18. A computer readable storage medium embodying computer programming logic that when executed on a processor performs the operations comprising:
determining whether an image comprises one or more elements;
determining, from the image, a manipulation of the one or more elements;
comparing a manipulation of the one or more elements to stored manipulations in memory to identify a manipulation that matches the manipulation of the one or more elements; and
in response to a match, performing a function on the imaging device that corresponds to the manipulation of the stored manipulation.

19. The computer readable storage medium of claim 18 wherein an object displayed in the viewing area receives a virtual touch from the one or more elements, wherein the touch is received at a location on the object that corresponds to a component within an image displayed on a screen of the imaging device, wherein the image is superimposed over the object, wherein the virtual touch causes selection of the component.

20. The computer readable storage medium of claim 18 further comprising storing manipulations in the memory, wherein the storing comprises:
capturing the manipulation of the one or more elements and one or more attributes associated with the manipulation;
assigning one or more functions to the manipulation; and
storing the manipulation, the function, and the one or more attributes in the memory.

21. The computer readable storage medium of claim 18 wherein the manipulation of the one or more elements activates a zoom operation of the imaging device, wherein the manipulation comprises:
moving the one or more elements in a pinching motion; or
moving an element of the one or more elements toward a screen of the imaging device then away from the screen;
wherein a distance of the zoom operation is determined by one or more attributes of the manipulation, the one or more attributes comprising a speed of the moving the element.
